(19) United States
(12) Patent Application Publication
(10) Pub. No.: US 2014/0358529 A1
(43) Pub. Date: Dec. 4, 2014

(54) Systems, Devices and Methods for Processing Speech Signals

(71) Applicant: Tencent Technology (Shenzhen) Company Limited, Shenzhen (CN)

(72) Inventor: Xiaoping Wu, Shenzhen (CN)

(73) Assignee: Tencent Technology (Shenzhen) Company Limited, Shenzhen (CN)

(21) Appl. No.: 14/165,764

(22) Filed: Jan. 28, 2014

Related U.S. Application Data
(63) Continuation of application No. PCT/CN2013/087674, filed on Nov. 22, 2013.

(30) Foreign Application Priority Data
May 29, 2013 (CN) 201310207404.3

(51) Int. Cl. G10L 19/07

(52) U.S. Cl. CPC G10L 19/07
USPC 704/206

(57) ABSTRACT

Systems and methods are provided for acquiring a smooth spectrum of speech signals. For example, linear-spectrum-pairs (LSP) parameters of one or more speech signals to be processed are acquired; one or more first cosine values of the LSP parameters are calculated; one or more second cosine values are calculated for one or more predetermined frequency points; one or more first smooth spectrum values of the one or more predetermined frequency points are calculated based on at least information associated with the first cosine values of the LSP parameters and the second cosine values of the predetermined frequency points; and a smooth spectrum of the speech signals is generated based on at least information associated with the first smooth spectrum values of the predetermined frequency points.

### CROSS-REFERENCES TO RELATED APPLICATIONS

This application claims priority to Chinese Patent Application No. 201310207404.3, filed May 29, 2013, incorporated by reference herein for all purposes.

### BACKGROUND OF THE INVENTION

The present invention is directed to computer technology. More particularly, the invention provides systems and methods for signal processing. Merely by way of example, the invention has been applied to speech signals. But it would be recognized that the invention has a much broader range of applicability.

For speech signal processing, a smooth spectrum of one or more received speech signals may be acquired so as to better analyze the characteristics of the speech signals. A smooth spectrum refers to a logarithmic amplitude spectrum obtained after removing effects associated with a base frequency from the speech signals.

A smooth spectrum of speech signals is often obtained as follows. First, linear-spectrum-pairs (LSP) parameters of certain speech signals are acquired. Then, the acquired LSP parameters are converted to linear-prediction-coding (LPC) parameters. Fast-Fourier-Transformation (FFT) is performed on the LPC parameters to obtain the smooth spectrum of the speech signals.

But the above-noted conventional approach often has some problems in practice. For example, a large amount of calculation is usually needed to convert the LSP parameters to the LPC parameters, which would be very time-consuming.

Hence it is highly desirable to improve the techniques for acquiring a smooth spectrum of speech signals.

### BRIEF SUMMARY OF THE INVENTION

The present invention is directed to computer technology. More particularly, the invention provides systems and methods for signal processing. Merely by way of example, the invention has been applied to speech signals. But it would be recognized that the invention has a much broader range of applicability.

According to one embodiment, a method is provided for acquiring a smooth spectrum of speech signals. For example, linear-spectrum-pairs (LSP) parameters of one or more speech signals to be processed are acquired; one or more first cosine values of the LSP parameters are calculated; one or more second cosine values are calculated for one or more predetermined frequency points; one or more first smooth spectrum values of the one or more predetermined frequency points are calculated based on at least information associated with the first cosine values of the LSP parameters and the second cosine values of the predetermined frequency points; and a smooth spectrum of the speech signals is generated based on at least information associated with the first smooth spectrum values of the predetermined frequency points.

According to another embodiment, a device for acquiring a smooth spectrum of speech signals includes a first processing module, a second processing module, and a third processing module. The first processing module is configured to acquire linear-spectrum-pairs (LSP) parameters of one or more speech signals to be processed. The second processing module is configured to receive the acquired LSP parameters, calculate one or more first cosine values of the LSP parameters, calculate one or more second cosine values for one or more predetermined frequency points, and calculate one or more first smooth spectrum values of the one or more predetermined frequency points based on at least information associated with the first cosine values of the LSP parameters and the second cosine values of the predetermined frequency points. The third processing module is configured to receive the calculated first smooth spectrum values and generate a smooth spectrum of the speech signals based on at least information associated with the first smooth spectrum values of the predetermined frequency points.

According to yet another embodiment, a non-transitory computer readable storage medium comprises programming instructions for acquiring a smooth spectrum of speech signals. The programming instructions are configured to cause one or more data processors to execute certain operations. For example, linear-spectrum-pairs (LSP) parameters of one or more speech signals to be processed are acquired; one or more first cosine values of the LSP parameters are calculated; one or more second cosine values are calculated for one or more predetermined frequency points; one or more first smooth spectrum values of the one or more predetermined frequency points are calculated based on at least information associated with the first cosine values of the LSP parameters and the second cosine values of the predetermined frequency points; and a smooth spectrum of the speech signals is generated based on at least information associated with the first smooth spectrum values of the predetermined frequency points.

In some embodiments, the systems and methods described herein are configured to obtain a smooth spectrum of speech signals without requiring conversion of LSP parameters into LPC parameters so that the amount of calculation and the calculation time may be reduced. In certain embodiments, the systems and methods described herein are configured to enable flexible selection of frequency points. For example, more frequency points are selected in a frequency range of major concern to obtain a more accurate smooth spectrum corresponding to the frequency range. In another example, fewer frequency points are selected in a frequency range of minor concern.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for acquiring a smooth spectrum of speech signals according to one embodiment of the present invention; and

FIG. 2 is a simplified diagram showing a device for acquiring a smooth spectrum of speech signals according to one embodiment of the present invention.

### DETAILED DESCRIPTION OF THE INVENTION

The present invention is directed to computer technology. More particularly, the invention provides systems and methods for signal processing. Merely by way of example, the invention has been applied to speech signals. But it would be recognized that the invention has a much broader range of applicability.

According to one embodiment, for certain speech signals, a smooth spectrum value of a frequency point is calculated according to the following equation:

d(ω)=−101 g|A(ω)|² (1)

where d(ω) represents the smooth spectrum value of the frequency point. A(ω) is calculated according to the following equation, according to certain embodiments.

$$A ( ω ) = {\sum }_{i = 0}^{p} {a}_{i} {e}^{- j ω i} \qquad ( 2 )$$

where a₀=1, aᵢ (i≠0) represents a linear-prediction-coding (LPC) parameter of the speech signals, and p represents a number of the LPC parameters which is equal to a number of linear-spectrum-pairs (LSP) parameters of the speech signals. In addition, | | represents a modular arithmetic calculation, ω represents the frequency point, and j represents the imaginary unit.

According to another embodiment, the LPC parameters are obtained through linear prediction coding of the speech signals. For example, the LSP parameters are another type of parameters for the speech signals, and the LSP parameters and the LPC parameters can be mutually converted, where the LSP parameters are between 0 and π.

According to yet another embodiment, based on the principles for converting the LPC parameters to the LSP parameters, the LSP parameters are obtained from roots of P(ω)=0 and Q(ω)=0, where P(ω) and Q(ω) are determined as below:

P(ω)=A(ω)+e^{-jω(p+1)}A(−ω) (3)

Q(ω)=A(ω)−e^{-jω(p+1)}A(−ω) (4)

where there are opposite roots for each of P(ω)=0 and Q(ω)=0.

In some embodiments, if p is an even number, π is a root of P(ω)=0 and 0 is a root of Q(ω)=0. For example, ±ωᵢ represent other roots of P(ω)=0, and ±θᵢ represents other roots of Q(ω)=0. As an example,

0<ω₁<θ₁<ω₂<θ₂< . . . <ω_{p/2}<θ_{p/2}<π (5)

If p is an odd number, 0 and π are both the roots of Q(ω)=0, in certain embodiments. For example, ±ωᵢ represent other roots of P(ω)=0, and ±θᵢ represents other roots of Q(ω)=0. As an example,

0<ω₁<θ₁<ω₂<θ₂< . . . <θ_{(p-1)/2}<ω_{(p+1)/2}<π (6)

According to one embodiment, the LSP parameters are larger than 0 and smaller than π, and thus none of 0, π, −ωᵢ, and −θᵢ can be used as a LSP parameter. That is, only +ωᵢ, and +θᵢ can be used as the LSP parameters, in some embodiments. For example, +ωᵢ, and +θᵢ are used alternately to represent the LSP parameters of the speech signals, such as (ω₁, θ₁, ω₂, θ₂, . . . ).

According to another embodiment, based on the equations (3) and (4), the following can be inferred:

|P(ω)+Q(ω)|=2|A(ω)| (7)

|P(ω)−Q(ω)|=2|A(ω)| (8)

According to the equations (7) and (8), P(ω) and Q(ω) are orthogonal to each other, in some embodiments. According to the Pythagorean Theorem, the following can be inferred, in certain embodiments:

$${\vert A ( ω ) \vert}^{2} = \frac{{\vert P ( ω ) \vert}^{2} + {\vert Q ( ω ) \vert}^{2}}{4} \qquad ( 9 )$$

In some embodiments, if p is an even number, there are p+1 roots for P(ω)=0, including π, +ωᵢ and −ωᵢ, where i is an integer between 1 and p/2. For example, P(ω) is determined as follows:

$$P ( ω ) = ( 1 - {e}^{j ( ω - π )} ) {\prod }_{i = 1}^{p / 2} [ ( 1 - {e}^{j ( ω - {ω}_{i} )} ) ( 1 - {e}^{j ( ω + {ω}_{i} )} ) ] \qquad ( 10 )$$

### Correspondingly,

$${\vert P ( ω ) \vert}^{2} = {2}^{p + 1} [ 1 + cos ( ω ) ] {\{ {\prod }_{i = 1}^{p / 2} [ cos ( ω ) - cos ( {ω}_{i} ) ] \}}^{2} \qquad ( 11 )$$

According to another embodiment, if p is an even number, there are p+1 roots for Q(ω)=0, including 0, +θᵢ and −θᵢ, where i is an integer between 1 and p/2. For example, Q(ω) is determined as follows:

$$Q ( ω ) = ( 1 - {e}^{j ω} ) {\prod }_{i = 1}^{p / 2} [ ( 1 - {e}^{j ( ω - {θ}_{i} )} ) ( 1 - {e}^{j ( ω + {θ}_{i} )} ) ] \qquad ( 12 )$$

### Correspondingly,

$${\vert Q ( ω ) \vert}^{2} = {2}^{p + 1} [ 1 - cos ( ω ) ] {\{ {\prod }_{i = 1}^{p / 2} [ cos ( ω ) - cos ( {θ}_{i} ) ] \}}^{2} \qquad ( 13 )$$

According to yet another embodiment, if p is an odd number, there are p+1 roots for P(ω)=0, including +ωᵢ and −ωᵢ, where i is an integer between 1 and (p+1)/2. For example, P(ω) is determined as follows:

$$P ( ω ) = {\prod }_{i = 1}^{( p + 1 ) / 2} [ ( 1 - {e}^{j ( ω - {ω}_{i} )} ) ( 1 - {e}^{j ( ω + {ω}_{i} )} ) ] \qquad ( 14 )$$

### Correspondingly,

$${\vert P ( ω ) \vert}^{2} = {2}^{p + 1} {\{ {\prod }_{i = 1}^{( p + 1 ) / 2} [ cos ( ω ) - cos ( {ω}_{i} ) ] \}}^{2} \qquad ( 15 )$$

According to yet another embodiment, if p is an odd number, there are p+1 roots for Q(ω)=0, including 0, π, +θᵢ and −θᵢ, where i is an integer between 1 and (p−1)/2. For example, Q(ω) is determined as follows:

$$Q ( ω ) = ( 1 - {e}^{jω} ) ( 1 - {e}^{j ( ω - π )} ) {\prod }_{i = 1}^{( p - 1 ) / 2} [ ( 1 - {e}^{j ( ω - {θ}_{i} )} ) ( 1 - {e}^{j ( ω + {θ}_{i} )} ) ] \qquad ( 16 )$$

### Correspondingly,

$${\vert Q ( ω ) \vert}^{2} = {2}^{p + 1} [ 1 - {cos}^{2} ( ω ) ] {\{ {\prod }_{i = 1}^{( p - 1 ) / 2} [ cos ( ω ) - cos ( {θ}_{i} ) ] \}}^{2} \qquad ( 17 )$$

A smooth spectrum of speech signals can be obtained based on what is described above, in some embodiments. For example, combining the equations (1), (9), (11), (13), (15) and (17), one or more cosine values of a frequency point and cosine values of the related LSP parameters (e.g., (ω₁, θ₁, ω₂, θ₂, . . . )) can be calculated. Then, cosine values of the frequency point and cosine values of the LSP parameters are inserted into the equations (11) and (13) or the equations (15) and (17) to obtain |P(ω)|² and |Q(ω)|² of the particular frequency point, in certain embodiments. For example, |A(ω)|² of the frequency point can be calculated based on the equation (9), and a smooth spectrum value d(ω) of the frequency point can be calculated based on the equation (1).

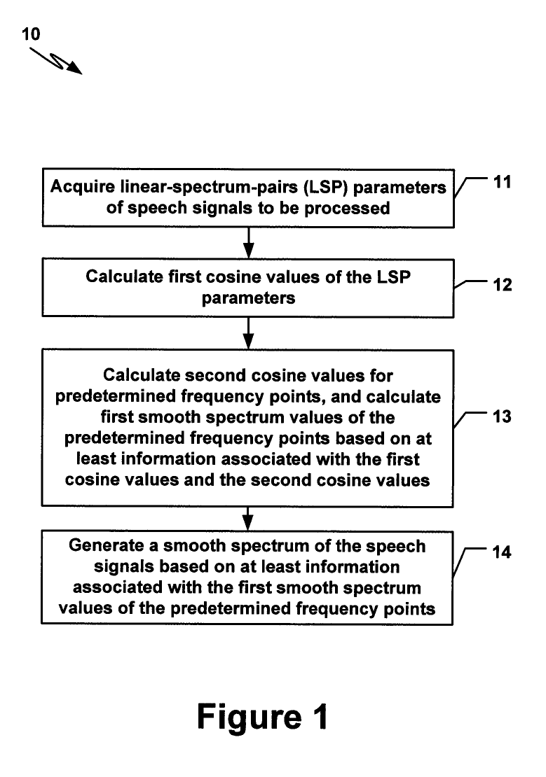

FIG. 1 is a simplified diagram showing a method for acquiring a smooth spectrum of speech signals according to one embodiment of the present invention. This diagram is merely an example, which should not unduly limit the scope of the claims. One of ordinary skill in the art would recognize many variations, alternatives, and modifications. The method 10 includes at least the process 11 for acquiring linear-spectrum-pairs (LSP) parameters of speech signals to be processed, the process 12 for calculating first cosine values of the LSP parameters, the process 13 for calculating second cosine values for predetermined frequency points and calculating first smooth spectrum values of the predetermined frequency points, and the process 14 for generating a smooth spectrum of the speech signals.

According to one embodiment, during the process 11, LSP parameters of one or more speech signals to be processed are acquired. For example, during the process 12, one or more first cosine values of the LSP parameters are calculated. Specifically, the LSP parameters are assigned to a first group and a second group based on at least information associated with a set of predetermined rules, in some embodiments. For example, cosine values for the LSP parameters assigned to the first group and cosine values for the LSP parameters assigned to the second group are calculated. As an example, based on the equations (11) and (15), cos(ωᵢ), instead of cos(θᵢ), are used for calculating |P(ω)|². In another example, based on the equations (13) and (17), cos(θᵢ), instead of cos(ωᵢ), are used for calculating |Q(ω)|². Thus, the LSP parameters corresponding to the roots of P(ω)=0 are assigned to the first group, and the LSP parameters corresponding to the roots of Q(ω)=0 are assigned to the second group, in certain embodiments. For example, cosine values of the LSP parameters in the first group and cosine values of the LSP parameters in the second group are calculated.

According to another embodiment, during the process 13, cosine values are calculated for each of a number of predetermined frequency points, and smooth spectrum values are calculated for each predetermined frequency point based on at least information associated with the cosine values of the LSP parameters and the cosine values of the predetermined frequency points. For example, one or more first intermediate values |P(ω)|² of a particular predetermined frequency point are calculated based on at least information associated with the cosine values of the LSP parameters in the first group and the cosine value of the particular predetermined frequency point. In addition, one or more second intermediate values |Q(ω)|² of the particular predetermined frequency point are calculated based on at least information associated with the cosine values of the LSP parameters in the second group and the cosine value of the particular predetermined frequency point.

In some embodiments, if p is an even number, that is, the number of the LSP parameters acquired during the process 11 is an even number,

$$\begin{matrix}{\vert P ( ω ) \vert}^{2} = {2}^{p + 1} [ 1 + cos ( ω ) ] {\{ {\prod }_{i = 1}^{p / 2} [ cos ( ω ) - cos ( {ω}_{i} ) ] \}}^{2} & ( 18 ) \\ {\vert Q ( ω ) \vert}^{2} = {2}^{p + 1} [ 1 - cos ( ω ) ] {\{ {\prod }_{i = 1}^{p / 2} [ cos ( ω ) - cos ( {θ}_{i} ) ] \}}^{2} & ( 19 )\end{matrix}$$

where cos(ωᵢ) represents the cosine values of the LSP parameters in the first group, cos(θᵢ) represents the cosine values of the LSP parameters in the second group, cos(ω) represents the cosine value of the predetermined frequency point, and | | represents a modular arithmetic calculation.

In certain embodiments, if p is an odd number,

$$\begin{matrix}{\vert P ( ω ) \vert}^{2} = {2}^{p + 1} {\{ {\prod }_{i = 1}^{( p + 1 ) / 2} [ cos ( ω ) - cos ( {ω}_{i} ) ] \}}^{2} & ( 20 ) \\ {\vert Q ( ω ) \vert}^{2} = {2}^{p + 1} [ 1 - {cos}^{2} ( ω ) ] {\{ {\prod }_{i = 1}^{( p - 1 ) / 2} [ cos ( ω ) - cos ( {θ}_{i} ) ] \}}^{2} & ( 21 )\end{matrix}$$

A smooth spectrum value d(ω) is calculated for the particular predetermined frequency point is calculated based on at least information associated with the calculated |P(ω)|² and |Q(ω)|², according to some embodiments. For example, |A(ω)|² is calculated as follows:

$${\vert A ( ω ) \vert}^{2} = \frac{{\vert P ( ω ) \vert}^{2} + {\vert Q ( ω ) \vert}^{2}}{4} \qquad ( 22 )$$

Then, the smooth spectrum value is calculated as follows:

d(ω)=−101 g|A(ω)|² (23)

According to certain embodiments, during the process 14, a smooth spectrum of the speech signals is generated based on at least information associated with the smooth spectrum values of the predetermined frequency points.

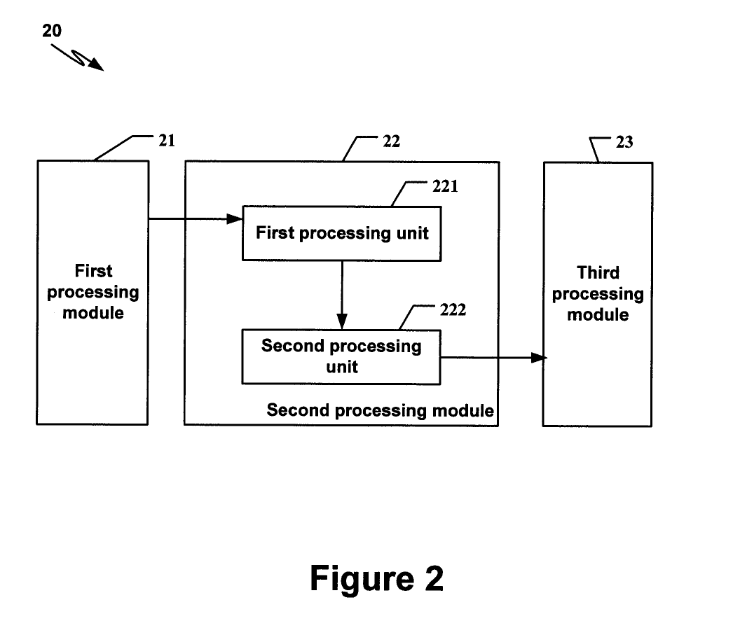

FIG. 2 is a simplified diagram showing a device for acquiring a smooth spectrum of speech signals according to one embodiment of the present invention. This diagram is merely an example, which should not unduly limit the scope of the claims. One of ordinary skill in the art would recognize many variations, alternatives, and modifications. The device 20 includes a first processing module 21, a second processing module 22, and a third processing module 23.

According to one embodiment, the first processing module 21 is configured to acquire LSP parameters of one or more speech signals to be processed and provide the acquired LSP parameters to the second processing module 22. For example, the second processing module 22 is configured to calculate one or more first cosine values of the LSP parameters, calculate one or more second cosine values for one or more predetermined frequency points, and calculate one or more first smooth spectrum values of the one or more predetermined frequency points based on at least information associated with the first cosine values of the LSP parameters and the second cosine values of the predetermined frequency points. In another example, the third processing module 23 is configured to receive the calculated first smooth spectrum values and generate a smooth spectrum of the speech signals based on at least information associated with the first smooth spectrum values of the predetermined frequency points.

According to another embodiment, the second processing module 22 includes a first processing unit 221 and a second processing unit 222. For example, the first processing unit 221 is configured to assign the LSP parameters to a first group and a second group based on at least information associated with a set of predetermined rules, calculate one or more third cosine values for the LSP parameters assigned to the first group, and calculate one or more fourth cosine values for the LSP parameters assigned to the second group. For example, the second processing unit 222 is configured to receive the third cosine values and the fourth cosine values, calculate one or more first intermediate values |P(ω)|² for a first predetermined frequency point based on at least information associated with the third cosine values and a fifth cosine value of the first predetermined frequency point, calculate one or more second intermediate values |Q(ω)|² of the first predetermined frequency point based on at least information associated with the fourth cosine values and the fifth cosine value, calculate a second smooth spectrum value for the first predetermined frequency point based on at least information associated with the |P(ω)|² and |Q(ω)|², and provide the calculated second smooth spectrum value to the third processing module.

In one embodiment, the first processing unit 221 is further configured to assign the LSP parameters corresponding to the roots of P(ω)=0 to the first group, and assign the LSP parameters corresponding to the roots of Q(ω)=0 to the second group. For example,

$$\begin{matrix}{\vert P ( ω ) \vert}^{2} = {2}^{p + 1} [ 1 + cos ( ω ) ] {\{ {\prod }_{i = 1}^{p / 2} [ cos ( ω ) - cos ( {ω}_{i} ) ] \}}^{2} & ( 24 ) \\ {\vert Q ( ω ) \vert}^{2} = {2}^{p + 1} [ 1 - cos ( ω ) ] {\{ {\prod }_{i = 1}^{p / 2} [ cos ( ω ) - cos ( {θ}_{i} ) ] \}}^{2} & ( 25 )\end{matrix}$$

where cos(ωᵢ) represents the third cosine values of the LSP parameters assigned to the first group, cos(θᵢ) represents the fourth cosine values of the LSP parameters assigned to the second group, and p represents a total number of the LSP parameters assigned to the first group and the second group. As an example, p is an even number, cos(ω) represents one of the second cosine values for the first predetermined frequency point, and | | represents a modular arithmetic calculation.

In another embodiment, the first processing unit 221 is further configured to assign the LSP parameters corresponding to the roots of P(ω)=0 to the first group, and assign the LSP parameters corresponding to the roots of Q(ω)=0 to the second group. For example,

$$\begin{matrix}{\vert P ( ω ) \vert}^{2} = {2}^{p + 1} {\{ {\prod }_{i = 1}^{( p + 1 ) / 2} [ cos ( ω ) - cos ( {ω}_{i} ) ] \}}^{2} & ( 26 ) \\ {\vert Q ( ω ) \vert}^{2} = {2}^{p + 1} [ 1 - {cos}^{2} ( ω ) ] {\{ {\prod }_{i = 1}^{( p - 1 ) / 2} [ cos ( ω ) - cos ( {θ}_{i} ) ] \}}^{2} & ( 27 )\end{matrix}$$

where cos(ωᵢ) represents the third cosine values of the LSP parameters assigned to the first group, cos(θᵢ) represents the fourth cosine values of the LSP parameters assigned to the second group, and p represents a total number of the LSP parameters assigned to the first group and the second group. As an example, p is an odd number, cos(ω) represents one of the second cosine values for the first predetermined frequency point, and | | represents a modular arithmetic calculation.

In yet another embodiment, the second processing unit is further configured to calculate |A(ω)|² as follows:

$${\vert A ( ω ) \vert}^{2} = \frac{{\vert P ( ω ) \vert}^{2} + {\vert Q ( ω ) \vert}^{2}}{4} \qquad ( 28 )$$

For example, the second processing unit is further configured to calculate the smooth spectrum value d(ω) of the first predetermined frequency point as follows:

d(ω)=−101 g|A(ω)|² (29)

According to one embodiment, a method is provided for acquiring a smooth spectrum of speech signals. For example, linear-spectrum-pairs (LSP) parameters of one or more speech signals to be processed are acquired; one or more first cosine values of the LSP parameters are calculated; one or more second cosine values are calculated for one or more predetermined frequency points; one or more first smooth spectrum values of the one or more predetermined frequency points are calculated based on at least information associated with the first cosine values of the LSP parameters and the second cosine values of the predetermined frequency points; and a smooth spectrum of the speech signals is generated based on at least information associated with the first smooth spectrum values of the predetermined frequency points. For example, the method is implemented according to at least FIG. 1.

According to another embodiment, a device for acquiring a smooth spectrum of speech signals includes a first processing module, a second processing module, and a third processing module. The first processing module is configured to acquire linear-spectrum-pairs (LSP) parameters of one or more speech signals to be processed. The second processing module is configured to receive the acquired LSP parameters, calculate one or more first cosine values of the LSP parameters, calculate one or more second cosine values for one or more predetermined frequency points, and calculate one or more first smooth spectrum values of the one or more predetermined frequency points based on at least information associated with the first cosine values of the LSP parameters and the second cosine values of the predetermined frequency points. The third processing module is configured to receive the calculated first smooth spectrum values and generate a smooth spectrum of the speech signals based on at least information associated with the first smooth spectrum values of the predetermined frequency points. For example, the device is implemented according to at least FIG. 2.

According to yet another embodiment, a non-transitory computer readable storage medium comprises programming instructions for acquiring a smooth spectrum of speech signals. The programming instructions are configured to cause one or more data processors to execute certain operations. For example, linear-spectrum-pairs (LSP) parameters of one or more speech signals to be processed are acquired; one or more first cosine values of the LSP parameters are calculated; one or more second cosine values are calculated for one or more predetermined frequency points; one or more first smooth spectrum values of the one or more predetermined frequency points are calculated based on at least information associated with the first cosine values of the LSP parameters and the second cosine values of the predetermined frequency points; and a smooth spectrum of the speech signals is generated based on at least information associated with the first smooth spectrum values of the predetermined frequency points. For example, the storage medium is implemented according to FIG. 1 and/or FIG. 2.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A processor-implemented method for acquiring a smooth spectrum of speech signals, the method comprising:
acquiring linear-spectrum-pairs (LSP) parameters of one or more speech signals to be processed;
calculating, using one or more data processors, one or more first cosine values of the LSP parameters;
calculating, using the data processors, one or more second cosine values for one or more predetermined frequency points;
calculating, using the data processors, one or more first smooth spectrum values of the one or more predetermined frequency points based on at least information associated with the first cosine values of the LSP parameters and the second cosine values of the predetermined frequency points; and
generating, using the data processors, a smooth spectrum of the speech signals based on at least information associated with the first smooth spectrum values of the predetermined frequency points.

2. The method of claim 1 wherein:
the calculating one or more first cosine values of the LSP parameters includes:
assigning the LSP parameters to a first group and a second group based on at least information associated with a set of predetermined rules;
calculating one or more third cosine values for the LSP parameters assigned to the first group; and
calculating one or more fourth cosine values for the LSP parameters assigned to the second group;
the calculating one or more first smooth spectrum values of the predetermined frequency points includes:
calculating one or more first intermediate values |P(ω)|² for a first predetermined frequency point based on at least information associated with the third cosine values and a fifth cosine value of the first predetermined frequency point;
calculating one or more second intermediate values |Q(ω)|² of the first predetermined frequency point based on at least information associated with the fourth cosine values and the fifth cosine value; and
calculating a second smooth spectrum value for the first predetermined frequency point based on at least information associated with the |P(ω)|² and the |Q(ω)|².

3. The method of claim 2 wherein:
the LSP parameters assigned to the first group include roots of P(ω)=0;
the LSP parameters assigned to the second group include roots of Q(ω)=0;
$$\begin{matrix}{\vert P ( ω ) \vert}^{2} = {2}^{p + 1} [ 1 + cos ( ω ) ] {\{ {\prod }_{i = 1}^{p / 2} [ cos ( ω ) - cos ( {ω}_{i} ) ] \}}^{2} , \\ {\vert Q ( ω ) \vert}^{2} = {2}^{p + 1} [ 1 - cos ( ω ) ] {\{ {\prod }_{i = 1}^{p / 2} [ cos ( ω ) - cos ( {θ}_{i} ) ] \}}^{2} ,\end{matrix}$$
where cos(ωᵢ) represents the third cosine values of the LSP parameters assigned to the first group, cos(θᵢ) represents the fourth cosine values of the LSP parameters assigned to the second group, and p represents a total number of the LSP parameters assigned to the first group and the second group;
p is an even number;
cos(ω) represents one of the second cosine values for the first predetermined frequency point; and

| | represents a modular arithmetic calculation.

4. The method of claim 2 wherein:
the LSP parameters assigned to the first group include roots of P(ω)=0;
the LSP parameters assigned to the second group include roots of Q(ω)=0;
$$\begin{matrix}{\vert P ( ω ) \vert}^{2} = {2}^{p + 1} {\{ {\prod }_{i = 1}^{( p + 1 ) / 2} [ cos ( ω ) - cos ( {ω}_{i} ) ] \}}^{2} , \\ {\vert Q ( ω ) \vert}^{2} = {2}^{p + 1} [ 1 - {cos}^{2} ( ω ) ] {\{ {\prod }_{i = 1}^{( p - 1 ) / 2} [ cos ( ω ) - cos ( {θ}_{i} ) ] \}}^{2} ,\end{matrix}$$
where cos(ωᵢ) represents the third cosine values of the LSP parameters assigned to the first group, cos(θᵢ) represents the fourth cosine values of the LSP parameters assigned to the second group, and p represents a total number of the LSP parameters assigned to the first group and the second group;
p is an odd number;
cos(ω) represents one of the second cosine values for the first predetermined frequency point; and

| | represents a modular arithmetic calculation.

5. The method of claim 2, wherein the calculating a second smooth spectrum value for the first predetermined frequency point based on at least information associated with the |P(ω)|² and the |Q(ω)|² includes:
$$calculating {\vert A ( ω ) \vert}^{2} = \frac{{\vert P ( ω ) \vert}^{2} + {\vert Q ( ω ) \vert}^{2}}{4} ;$$
and
calculating d(ω)=101 g|A(ω)|², where d(ω) represents the second smooth spectrum value of the first predetermined frequency point.

6. A device for acquiring a smooth spectrum of speech signals, the device comprising:
a first processing module configured to acquire linear-spectrum-pairs (LSP) parameters of one or more speech signals to be processed;
a second processing module configured to receive the acquired LSP parameters, calculate one or more first cosine values of the LSP parameters, calculate one or more second cosine values for one or more predetermined frequency points, and calculate one or more first smooth spectrum values of the one or more predetermined frequency points based on at least information associated with the first cosine values of the LSP parameters and the second cosine values of the predetermined frequency points; and
a third processing module configured to receive the calculated first smooth spectrum values and generate a smooth spectrum of the speech signals based on at least information associated with the first smooth spectrum values of the predetermined frequency points.

7. The device of claim 6 wherein the second processing module includes:
a first processing unit configured to assign the LSP parameters to a first group and a second group based on at least information associated with a set of predetermined rules, calculate one or more third cosine values for the LSP parameters assigned to the first group, and calculate one or more fourth cosine values for the LSP parameters assigned to the second group;
a second processing unit configured to receive the third cosine values and the fourth cosine values, calculate one or more first intermediate values |P(ω)|² for a first predetermined frequency point based on at least information associated with the third cosine values and a fifth cosine value of the first predetermined frequency point, calculate one or more second intermediate values |Q(ω)|² of the first predetermined frequency point based on at least information associated with the fourth cosine values and the fifth cosine value, calculate a second smooth spectrum value for the first predetermined frequency point based on at least information associated with the |P(ω)|² and the |Q(ω)|², and provide the calculated second smooth spectrum value to the third processing module.

8. The device of claim 7 wherein the first processing unit is further configured to assign the LSP parameters to the first group and the second group, the LSP parameters assigned to the first group including roots of P(ω)=0, the LSP parameters assigned to the second group including roots of Q(ω)=0;
wherein:
$$\begin{matrix}{\vert P ( ω ) \vert}^{2} = {2}^{p + 1} [ 1 + cos ( ω ) ] {\{ {\prod }_{i = 1}^{p / 2} [ cos ( ω ) - cos ( {ω}_{i} ) ] \}}^{2} , \\ {\vert Q ( ω ) \vert}^{2} = {2}^{p + 1} [ 1 - cos ( ω ) ] {\{ {\prod }_{i = 1}^{p / 2} [ cos ( ω ) - cos ( {θ}_{i} ) ] \}}^{2} ,\end{matrix}$$
where cos(ωᵢ) represents the third cosine values of the LSP parameters assigned to the first group, cos(θᵢ) represents the fourth cosine values of the LSP parameters assigned to the second group, and p represents a total number of the LSP parameters assigned to the first group and the second group;
p is an even number;
cos(ω) represents one of the second cosine values for the first predetermined frequency point; and

| | represents a modular arithmetic calculation.

9. The device of claim 7 wherein the first processing unit is further configured to assign the LSP parameters to the first group and the second group, the LSP parameters assigned to the first group including roots of P(ω)=0, the LSP parameters assigned to the second group including roots of Q(ω)=0;
wherein:
$$\begin{matrix}{\vert P ( ω ) \vert}^{2} = {2}^{p + 1} {\{ {\prod }_{i = 1}^{( p + 1 ) / 2} [ cos ( ω ) - cos ( {ω}_{i} ) ] \}}^{2} , \\ {\vert Q ( ω ) \vert}^{2} = {2}^{p + 1} [ 1 - {cos}^{2} ( ω ) ] {\{ {\prod }_{i = 1}^{( p - 1 ) / 2} [ cos ( ω ) - cos ( {θ}_{i} ) ] \}}^{2} ,\end{matrix}$$
where cos(ωᵢ) represents the third cosine values of the LSP parameters assigned to the first group, cos(θᵢ) represents the fourth cosine values of the LSP parameters assigned to the second group, and p represents a total number of the LSP parameters assigned to the first group and the second group;
p is an odd number;
cos(ω) represents one of the second cosine values for the first predetermined frequency point; and

| | represents a modular arithmetic calculation.

10. The device of claim 7, wherein the second processing unit is further configured to calculate
$${\vert A ( ω ) \vert}^{2} = \frac{{\vert P ( ω ) \vert}^{2} + {\vert Q ( ω ) \vert}^{2}}{4} ,$$
and calculate d(ω)=−101 g|A(ω)|², where d(ω) represents the second smooth spectrum value of the first predetermined frequency point.

11. The device of claim 6, further comprising:
one or more data processors; and
a computer-readable storage medium;
wherein one or more of the first processing module, the second processing module, and the third processing module are stored in the storage medium and configured to be executed by the one or more data processors.

12. A non-transitory computer readable storage medium comprising programming instructions for acquiring a smooth spectrum of speech signals, the programming instructions configured to cause one or more data processors to execute operations comprising:
acquiring linear-spectrum-pairs (LSP) parameters of one or more speech signals to be processed;
calculating one or more first cosine values of the LSP parameters;
calculating one or more second cosine values for one or more predetermined frequency points;
calculating one or more first smooth spectrum values of the one or more predetermined frequency points based on at least information associated with the first cosine values of the LSP parameters and the second cosine values of the predetermined frequency points; and
generating a smooth spectrum of the speech signals based on at least information associated with the first smooth spectrum values of the predetermined frequency points.
